(19) United States
(12) Patent Application Publication
(10) Pub. No.: US 2012/0330854 A1
(43) Pub. Date: Dec. 27, 2012

(54) DISTRIBUTABLE REFERRAL DIRECTORY

(76) Inventor: Edwin J. MacLaughlin, Hermosa Beach, CA (US)

(21) Appl. No.: 13/539,064

(22) Filed: Jun. 29, 2012

Related U.S. Application Data
(63) Continuation-in-part of application No. 12/777,248, filed on May 10, 2010.
Application No. 12/777,248 is a continuation-in-part of application No. 13/441,547, filed on Apr. 6, 2012.
(60) Provisional application No. 61/502,492, filed on Jun. 29, 2011.
(60) Provisional application No. 61/215,675, filed on May 8, 2009.
(60) Provisional application No. 61/280,124, filed on Oct. 30, 2009.
(60) Provisional application No. 61/284,251, filed on Dec. 15, 2009.
(60) Provisional application No. 61/336,655, filed on Jan. 25, 2010.
(60) Provisional application No. 61/336,682, filed on Jan. 25, 2010.
(60) Provisional application No. 61/472,544, filed on Apr. 6, 2011.

(51) Int. Cl. G06Q 99/00

(52) U.S. Cl. 705/319

(57) ABSTRACT

A user-content generated network is provided for presenting business listings, as well as commentary and reviews of businesses, by participants of the network. In an embodiment, businesses can participate in the network and receive referrals from members of the network. The network can track and monitor referrals that individual businesses receive as a mechanism for promoting the business to other users in the network's user base.

### RELATED APPLICATION

This application claims benefit of priority to Provisional U.S. Patent Application No. 61/502,492, filed Jun. 29, 2011; the aforementioned priority application being hereby incorporated.

This application is a continuation-in-part of U.S. patent application Ser. No. 12/777,248, filed May 10, 2010; which claims benefit of priority to U.S. Provisional Patent Application No. 61/215,675, filed May 8, 2009; U.S. Provisional Patent Application No. 61/280,124 filed Oct. 30, 2009; U.S. Provisional Patent Application No. 61/284,251, filed Dec. 15, 2009; U.S. Provisional Patent Application No. 61/336,655, filed Jan. 25, 2010; and U.S. Provisional Patent Application No. 61/336,682, filed Jan. 25, 2010; and all of the aforementioned applications are hereby incorporated by reference in their respective entirety.

This application is a continuation-in-part of U.S. patent application Ser. No. 13/441,547, filed Apr. 6, 2012, which claims benefit of priority to Provisional U.S. Patent Application No. 61/472,544, filed Apr. 6, 2011, the aforementioned priority application being hereby incorporated by reference in its entirety.

### TECHNICAL FIELD

Embodiments described herein pertain generally to a system and method for operating a referral network in a social networking environment.

### BRIEF DESCRIPTION OF THE DRAWINGS

FIG. 1 illustrates a system for providing a referral network in a social networking environment, according to one or more embodiments.

FIG. 2 illustrates a method for enabling a business to establish referral links with participants of a social network, according to one or more embodiments.

FIG. 3 illustrates a method for performing referral searching, according to an embodiment.

FIG. 4 illustrates a search result page that is generated for a user seeking to locate a business, in accordance with various embodiments described herein.

FIG. 5 illustrates a personal directory page, according to an embodiment.

FIG. 6 illustrates a detailed view of the review-referral board shown in FIG. 1.

FIG. 7 illustrates a user dashboard for a personal directory, according to an embodiment.

FIG. 8 illustrates a personal directory page, according to another embodiment.

### DETAILED DESCRIPTION

Embodiments described herein enable formation of referral networks in a social networking environment.

According to some embodiments, a user-content generated network is provided for presenting business listings, as well as commentary and reviews of businesses, by participants of the network. In an embodiment, businesses can participate in the network and receive referrals from members of the network. The network can track and monitor referrals that individual businesses receive as a mechanism for promoting the business to other users in the network's user base.

As used herein, a user-content generated network is a network of interlinked network resources (e.g. web pages) that publish content generated from users of the network. As an example, a social network is a user-content generated network.

In an embodiment, the user-content generated network is operated as a social network, in that participants are provided a web page or other online resource, and enabled to link to other participants through their respective web page or online resource. In this context, referrals to business participants appear as referral links. In one embodiment, a person or other participant of the network (e.g. group or organization) is able to express a recommendation or endorsement of a business by creating a referral link to the business participant being recommended/endorsed. A referral link is a link data structure (e.g. URL) that is published on the user's web page or online resource, and it provides an expression or affirmation of a business by the person publishing the link. According to some embodiments, data from referral links can be tallied and analyzed in order to affect how information about businesses are listed or otherwise presented.

In an embodiment, a network resource is associated to an organization. The network resource provides a medium on which the organization can publish information about itself and/or its products or services. Each participant in a population of participants of a social network is associated with a corresponding network resource (e.g. web page). An organization is able to participate by requesting other participants (e.g. individual participants in the population who have a relationship with the organization, and/or other organizations), to link their respective corresponding network resource with the network resource of the organization. Information is stored that identifies (i) a plurality of organizations, (ii) individual participants in the population, and (iii) links between each of the plurality of organizations and individual users in the population and/or other organizations in the plurality of organizations, wherein the links between each of the plurality of organizations and the individual users include referral links.

One or more embodiments provide an interface for the user-content generated network in the form of a distributable application. For example, the application may be integrated into a registered user's website, blog, or existing social media network to allow a viewer of the page to simultaneously interface with the user-content generated network.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

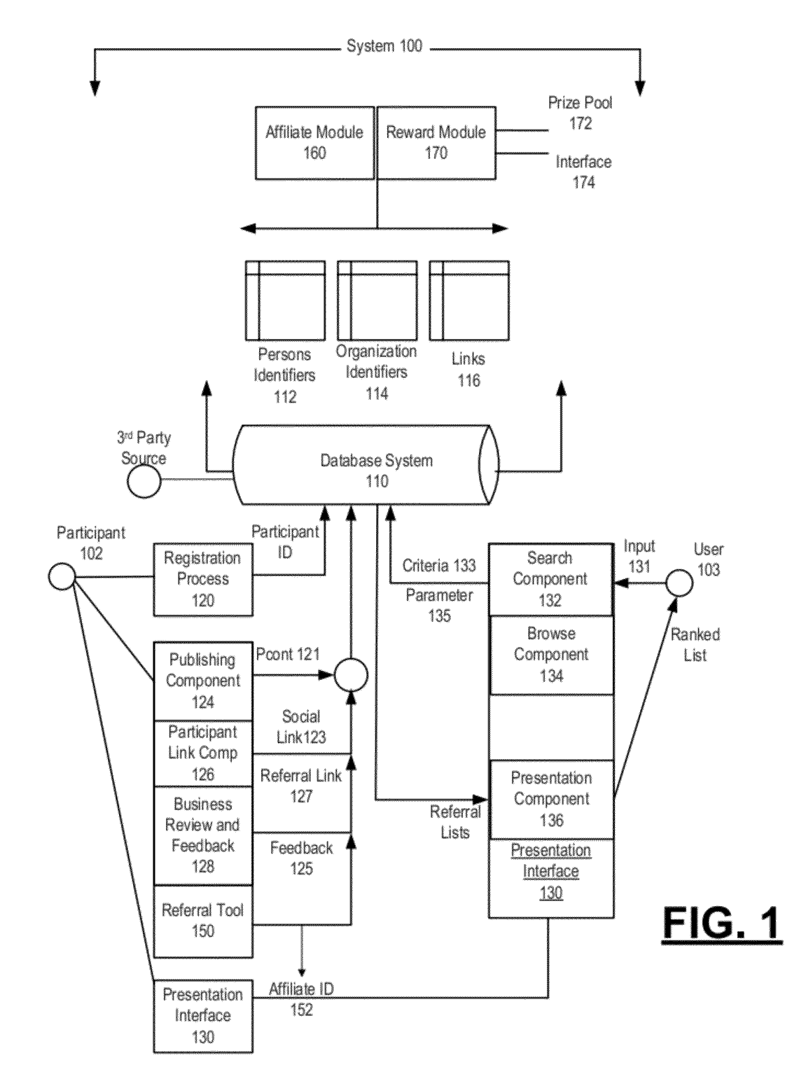

FIG. 1 illustrates a system for providing a referral network in a social networking environment, according to one or more embodiments. More specifically, a system 100 such as shown by FIG. 1 enables participants to perform social networking activities, including (i) maintaining online resources, such as a webpage, (ii) using the online resource to publish and share information and content with other users, (iii) link to and/or from networks of friends, families, professional acquaintances and others, whom the user wishes to designate as part of their ‘network’. In this context, embodiments provide the system 100 enables individual participants to make referral links to businesses and organizations.

Referral links include data elements or structures (e.g. URL links) that programmatically link a webpage or other online resource of the referral-making participant with the online resource/webpage of the party that is receiving the referral. Semantics and other content may be associated with the referral link in order to identify the party receiving the referral. The semantics and other surrounding content can serve to communicate that the link is being provided as an affirmative expression of referral. For example, the link can include one or more of the following semantic/contextual characteristics: (i) name of business displayed with link on user's online resource or page; (ii) name of business displayed with link in directory portion of user's online resource or page; and/or (iii) name of business displayed in prominence (e.g. highlighted, colored, bolded, enlarged, separated) from other links in the same region of the user's web page or online resource. In this way, the referral links enable individual participants to express recommendation or endorsement of a particular business or organization by linking an online resource of the endorsed/recommended business to the online resource maintained for the individual on the system 100.

The system 100 may be implemented as a Web service, such as provided at a website. In such implementation, the service can be implemented by a combination of computers (devices that include processors or processing resources), such as by servers that implement a client/server architecture. Alternatively, a peer-to-peer network or hybrid network infrastructure may be implemented. Still further, some embodiments may be implemented in connection with the existing social networking services. For example, a referral network aspect of embodiments described can be combined with existing social networking sites and services.

According to some embodiments, the participants of system 100 include persons and organizations. Organizations can include businesses, as well as associations, nonprofit organizations, or groups that share common interests (e.g. hobbyists) or other characteristics (e.g. neighborhood groups). In various embodiments, participants may also include additional classifications that include: registered and unregistered, premium participant (e.g. one who pays, or pays extra) and non-premium customer.

According to some embodiments, system 100 includes a database system 110 that manages structured relational data sets corresponding to persons identifier dataset 112, organizations identifier dataset 114, and linked to dataset 116. The individual datasets (e.g. table(s)) can form either a separate or integrated portion of another dataset. The persons identifier data set 112 includes information that identifies participants that are persons. This information may include the person's name, moniker, e-mail address, as well as demographic or personal information (e.g. sex and age), the interest of the user, and content that the person publishes or shares. The persons identifier dataset 112 may maintain such information, or include pointers or links to such information.

Likewise, the organization identifier dataset 114 includes or identifies information about businesses and organizations. This may include business name, the location or locations of the business, content about the business and/or the products or services offered by the business (e.g. product pictures of store or product), out-of-network endorsements of the products or business etc (e.g. Better Business Bureau approval, link to reviews at other websites). In some implementations, the information associated with participants (persons and organizations) is formatted as Web content and made renderable on a unique web resource that is assigned to that particular participant. The web resource of each participant forms a webpage (or portion thereof) that includes various pieces of content and information that are provided by that participant for others to view. The web resource can be uniquely identified by a URL or other identifier.

The link dataset 116 provides linking information between participants of the social/referral network provided with system 100. As mentioned, system 100 can enable a social networking environment, in which participants socially link to one another so as to be part of one another social network. Additionally, some embodiments enable participants to create referral links. Referral links can serve as expressions of endorsement or recommendation. The referral links can be provided as a direct link on a referring participant's online resource. When published on a referring participant's webpage, for example, the referral link locates the online resource or webpage of the participant that is receiving the referral. The link dataset 116 maintains the various links between participants of system 100.

System 100 includes a plurality of modules that combine to provide various functions and services, as described below by the various components, processes and other functionality. According to one or more embodiments, a participant 102 interacts with a registration process 120 to register with system 100. The participant's interaction with the registration process 120 includes specifying account information, including the name of the participant, login and password, preference designations, and contact information (e.g. email address). In the case where the participant 102 is a person, the participant 102 may enter demographic or profile information, such as the age and sex of the participant. In the case where the participant 100 is a business or organization, the participant 102 may identify and/or classify the business (tags, categories, sub-categories), as well as products and services offered by the business. Participants may also enter information about their preferences and privacy, such as who may view their webpage or specific information provided with their webpage. Various other preferences, settings, and information can be provided by participants 102 during the registration process 120. Information determined through the registration process may be recorded in the relevant persons or organizations data sets 112, 114.

Various user-interface features can be implemented on system 100 to enable activities such as content publishing and referral linking. In one embodiment, the user's interaction with system 100 may include (i) interaction with features provided with their personal web page or online resource, (ii) interactions provided with features provided as a global resources (e.g. search tool, home page), and/or (iii) features that one user can interact with on another participant's webpage or resource. Specific activities that can be enabled with the various features include (i) content publishing (e.g. linking to other content, publishing text authored by participant, uploading images and other media), (ii) referral linking, (iii) social linking, (iv) searching and (v) browsing. Specific examples of user-interface features include a text entry box, a menu, functional icons, search box, link generator, upload manager and preview tool. With regard to link generation, a link generator can be used to generate social and referral links, by creating links (e.g. URL) to a specified webpage or resource.

Subsequent to the registration process 120, the participant 102 can publish content using the publication component 124. Various types of information can be published by persons and/or businesses. Participants 102 can publish personal content 121 text, images, web content, multimedia, and other content in order to share information with their network and/or users of system 100. The personal content 121 can be published as a link to a source for the content, or as the content itself. Personal content 121 may also include social network links, including links to groups that participant 102 subscribed to or is a member of, as well as links to persons or other participants with whom participant 102 is socially linked to.

In addition to personal content 121, participant 102 can use a participant link component 126 to generate and publish social links 123 and referral links 127. Social links 123 correspond to links that enable a viewer of the particular webpage or online resource to open a corresponding webpage/resource of another participant with whom that person has a social or personal relationship with. Referral links are similar to social links, in that referral links can be selected to enable a viewer of the participant's page to see the webpage or resource of the participant identified by the link. But referral links can be presented differently from social links in that the participant is linking to a business or organization, the referral link is provided with context that indicates the person publishing the link is making an affirmative referral (or endorsement) of the business or organization that is identified by the link.

When generating a referral link, participant 102 identifies a business or organization that he or she wants to refer. In one embodiment, the link component 126 can include functionality provided on the participant's online webpage or resource, as well as functionality provided at the website or otherwise by system 100 independent of the participant's webpage or resource. The link component 126 operates to identify a participant business or organization from user input. The user may, for example, specify the participant business or organization by name, identify their webpage or online resource, or identify the business using a directory (e.g. one generated from the database system 110 for a category and/or geography specified by the user). Once the participant business or organization is identified, the link component 126 generates the link (social or referral) between the participant's page (the one making the referral) and the webpage or online resource of the participant that is being linked. The social and referral links 123, 127 can be stored or associated in the database system 110. When the social and referral links 123, 127 are generated, the publishing component 124 then publishes the social/referral links as part of the referring participant's online resource (e.g. web page).

In one implementation, referral links 127 are presented to semantically identify the business or organization, and include data (e.g. URL) that can be selected to programmatically link a particular participants web browser or application to the referred party's web resource (as hosted through system 100 or otherwise). The referral links 127 can be provided separate and apart from social links 123 in order to enable the participant who is making the referral link express his endorsement or recommendation of the business receiving the referral link.

As an addition or alternative, the referral links 127 can be published in the form of a business directory on the participant's page. A visitor of a given participant's page can easily see businesses that the given participant has linked to, conveying a level or endorsement or approval by the linking participant. For example, each participant 102 can maintain a directory page that includes referral links to businesses and organizations participant wishes to endorse or recommend.

The link data set 116 may maintain information generated from the link component 126. The link information includes social links 123 and referral links for individual participants.

Additionally, some embodiments enable participants to provide feedback 125 about businesses and organizations using a feedback component 128. The types of information that can be entered as feedback include quantitative recommendations, such as provided in paragraph form, and ratings (e.g. numeric ratings on a scale of highest/lowest). In some implementations, feedback 125 is associated with the business or organization that is also the participant of system 100. Thus, feedback 125 can be published on the publishing participants webpage, as well as accounted for (or published) on the online resource of the business/organization receiving the feedback.

Still further, the user may provide feedback 125 for a business or organization that is not a registered participant or user system 100. The system 100 may maintain information for nonparticipant businesses and organizations, particularly by way of reviews and other feedback.

A presentation interface 130 enables the participant 102 to view content provided by other participants. In particular, while some content provided by participants can be held private or closed to the public, other content provided on system 100 may be published for all participants, or alternatively, for all users (including non-participants, such as unregistered users). More specifically, the participant 102 can correspond to user 103 that is registered, or otherwise a subscriber of the service provided by system 100, in that the participant 102 can publish content and make referral links. In some embodiments, system 100 can be made available to users who are not registered, but have the ability to view content provided by participants 102 and/or other publishers of system 100. Thus, the user 103 may represent a participant (e.g. someone who has rights to publish and make referral links), or an unregistered user.

In one embodiment, presentation interface 130 includes a search component 132. The search component 132 receives input 131, corresponding to criteria 133 (information expressed by user) and/or search parameters 135 (information inferred from user or user input), from which it can search for and identify participants using the datasets of the database system 110. The search component 132 can be used to search for participants of all classifications, including persons, businesses, and/or organizations or groups. In one variation, search component 132 is used to search for businesses including businesses that are participants of system 100, as well as those who are not participants. To such end, the database management system 110 may also procure information from third-party sources, such as online directories, yellow pages, and other social networking sites.

For business searching, search component 132 users search criteria that specifies a classification, category, or subcategory of the business or product desired by user 103. For example, the user may specify a plumber as a classification for the business, or alternatively, the brand name the user desires for a finished plumbing product. The search criteria can also specify subcategories, such as, finished plumbing, residential plumbing, or commercial plumbing. Still further, search criteria can specify other characteristics that are specified by the user, including non-network recommendations or information such as provided by the Better Business Bureau or Consumer Reports. The user can specify various other inputs as criteria, such as whether the business satisfies equal opportunity employment criteria or standards. Another criteria that can be imported by the user is geographic location. The user may specify the geographic location of the business he is seeking, or system 100 may infer the geographic location as being one that is proximate to the known location of the user.

In addition to the use of search criteria and/or parameters, some embodiments enable search component 132 to perform referral searching. In referral searching, the user 103 is able to specify additional search criteria or parameters that pertain to criteria stemming from tabulation or analysis of referral links between businesses and referring participants. In one embodiment, referral searching enables the user 103 to specify criteria and/or search parameters for a business that is referred by a particular participant (e.g. a trusted friend or relative of user 103) or class of participants (e.g. all participants in the user's social or referral network).

In one embodiment, the user can perform a referral search by searching for a business on another participant's online resource or directory. More specifically, each participant's webpage includes referral links to a set of businesses or organizations. The user 103 can search for a type of business (e.g. plumber) from the given participants webpage, so as to view businesses that are of the specified type and which have referral links on the given participant's page.

As an alternative or variation, the user may specify the participant and search parameter from the main page of system 100, or another user's participant page, for a business of a particular type. Still further, the user may specify a class of participants (e.g. those participants that are part of the user's network; those participants that are part of the user's network and in the user's geographic zone) and the type of business in order to identify businesses of the specified type that have received referral links from the class of participants identified by the participant.

In addition to search component 132, the browsing component 134 enables the user to browse various businesses, organizations and other participants by classifications, categories, and tag such as those specified by search terms. Thus, for example, the user can browse for businesses by type, geographical area, and other classifications or categories.

According to some embodiments, the presentation component 136 enables search results and category listings (such as provided for browsing) to be displayed to the user with information that reflects referral linked data. More specifically, the information may be presented to the user to reflect a ranking or prioritization, as determined by referral link data. As described elsewhere, referral link data can incorporate a tally of referral links to a given business, as well as consideration of who provided the referral link.

In some embodiments, the presentation component 136 lists businesses in response to search results or browsing activities. The lists can be ranked or prioritized using parameters that are based on referral links. For example, for a given list, businesses may be ranked according to factors, such as one or more of: (i) a number of businesses that received referral links to participants of system 100; (ii) a number of businesses that received referral links to participants that are in a social sub-network of the particular user viewing the ranked list; (iii) a number of businesses that received referral links to participants that are in a geographic region of the user viewing the ranked list; and/or (iv) businesses, optionally classified by category or parameter, ranked by which has the most referral links.

As an addition or variation to ranking, the referral link data may be tabulated or otherwise listed to users as a means of providing additional information about the business.

The presentation component 136 may present the ranked list in different ways. In one embodiment, a business or organization having the highest ranking (e.g. highest tally of referral links) is provided the most prominent position in the list-usually the top position of the list, with succeeding lesser rank entries being positioned in descending order from the highest position. In another embodiment, the ranking, as determined by referral links, are presented in prominence with graphics and/or other features, such as tallying or underlining the business that has the most referral links (or most referral links from the user's network etc.) in a list. Still further, some embodiments provide for providing tallies, or counts of the number of referral links, for each business. Such values provide a mechanism for ranking individual businesses on a list, by displaying a ranked value that is based on the businesses referral links as part of the list entry for that business.

According to some embodiments, information maintained by the database system can be used for various commercial and business applications. These include, for example, reward programs, promotions, and market survey projects. In some embodiments, an affiliate program may be implemented on system 100 to spur growth and use of a service provided by system 100. In one embodiment, a registration tool 150 is published on individual users web page or resource. The registration tool 150 can be operated by users who want to register or otherwise become a participant of the service 150. The registration tool 150 prompts, or influences a user at a particular participants web page or resource to register. When this occurs, the participant who provided the registration tool 150 is given credit for the new participant's enrollment. Other mechanisms for crediting enrollment of new participants to existing participants may also be used. For example, whenever a new participant enrolls, he may be asked who referred him to the service, and his answer may be used to identify the participant who is to be provided credit.

Various services to promote network interactions and growth, as well as business opportunities and network revenue can be integrated with functionality described with embodiments of FIG. 1.

In one embodiment, an affiliate program 160 executes on data that identifies which participants are credited for enrollment of other participants. In particular, a reward module 170 may be integrated with the system 100 to enable the affiliate program to reward participants for revenue generated from other participants that they directly refer, as well as for revenue from participants referred by those participants who were directly referred (i.e. two tiered).

Methodology

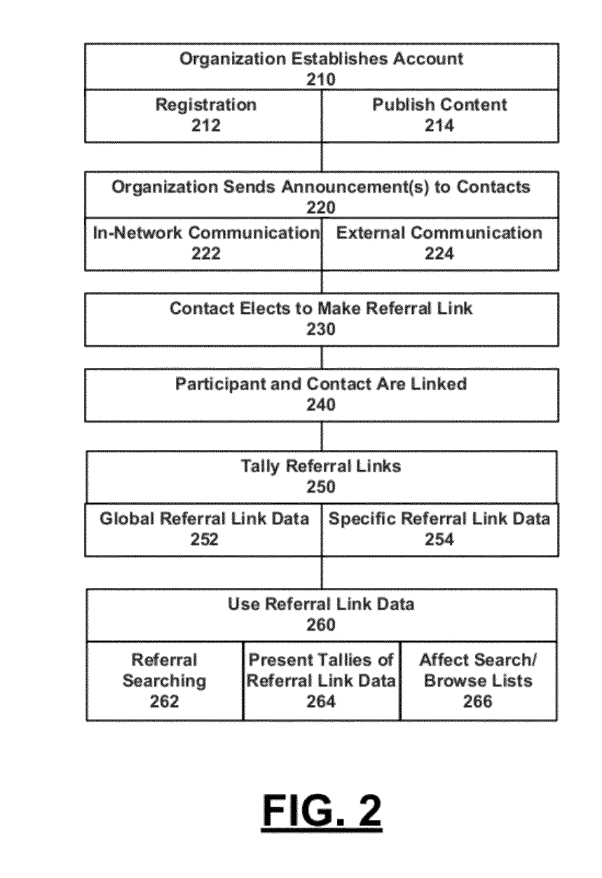

FIG. 2 illustrates a method for enabling a business to establish referral links with participants of a social network, according to one or more embodiments. A method such as described by FIG. 2 may be implemented using components such as described by an embodiment of FIG. 1. Accordingly, reference is made to elements of FIG. 1 for purpose of illustrating suitable elements or components for performing a step or sub-step being described.

In an embodiment, an organization establishes an account with the social network that is sustained on system 100 (210). The organization can correspond to the business, in association, or a non-structured affiliation (e.g. persons who share a common interest or hobby). For purpose of providing an example, in describing an embodiment of FIG. 2, the organization is assumed to be a business, and more specifically, a store or other small business that is local to a particular neighborhood or town. An operator of the business may interact with the registration component 110 in order to establish an account (212).

As an addition or variation, the business may also publish content (214) that promotes or provides information about the business and its products. For example, the web content may include text, pictures, media and links to products/services offered by the business, including online catalogs, lists of services offered and/or prices, and menus.

Once the organization is a participant of system 100, the organization may send announcements to its customers and/or associates or contacts (220). The announcement may invite the receiver of the announcement to make a referral link over the system 100. The communication can be sent through communication mediums offered through system 100 (e.g. in-network messaging service) (222), as well as through external communication mediums such as emails (224).

A person or organization that receives the communication from the business can elect to make a referral link (230). If the contact (person or organization) is already a participant of system 100, the participant simply uses functionality provided with the service to establish a link between that contact's webpage and the business that sent out the announcement. The referral link that is generated is published on the contact's webpage, as provided through system 100. The contact can, of course, elect to not link to the business that sent out the announcement.

If the contact who received the announcement is not a participant of system 100, the contact can elect to become a participant of the social network provided through system 100. For example, the contact may complete the registration process and become a participant. Then the contact can make the referral link on his or her respective web page or resource.

System 100 then associates the referral link with the organization who requested the referral link (240). The presence of the referral link has a variety of applications with system 100. According to some embodiments, data derived from referral links is used to enable participants to search, browse and/or view businesses that they may want to use.

In one embodiment, for the business or organization that receives referral links, the total tally or count of the referral links can be determined (250). The tally can consider referral links globally (252), as well as relationally or by categorically in order to generate user specific referral link information (254).

The referral link data can then be used in various forms (260). In one embodiment, the referral link data is used for referral searching (262), in order to search and identify businesses or organizations by classification (e.g. business type) and other criteria, as well as by information that is about referral links (e.g. those businesses that have threshold number of referral links, most referral links of a category, or who have been referred by a particular person or class of persons etc.).

Other uses for referral link data include tallying referral link data (globally, or specific to a given user) and presenting tallies of a given business participant's referral link data to another participant (264).

Still further, search or browsing lists can be affected with determination and/or presentation of the referral link data (266). For example, such lists can be ranked based in part on the referral link data. As a variation, select entries can be placed in prominence, or the list of entries can be enhanced with tabulation and co-presentation of the referral link data.

As an alternative or variation, the presence of the referral link enables referral searching features for the business or organization that receives the referral link. Under referral searching, a user (participant or unregistered user) can specify, as an additional search criteria or parameter, information that is specific to the business's referral links. Specific examples include (i) a person or persons who have referral links to the business or organization, (ii) a tally or count of the number of participants that have referral links to the business.

As still another variation, data pertaining to a business's referral links can be incorporated into how the business is listed by category or classification for browsing activities of individual users. For example, a participant person who is browsing for services may be presented businesses in their region that have the highest number of referral rakings.

Numerous other variations for incorporating referral linking into searching and/or browsing activities of users of system 100 exist.

The following provides an example of how embodiments such as described with FIG. 2 can be implemented. the network is configured to enable a business, which for this example will be “Joe's Plumbing” (a plumbing company, which may be a sole proprietorship or larger company), to sign up for a personal directory page on the Referral Network. In one embodiment, the personal directory page signup is free, so that Joe's Plumbing can sign up and set up its personal directory page without cost. Joe's Plumbing can then go to its friends, customers, fellow business, other associates, etc., and ask them to go to the referral network and to: (1) visit the “Joe's Plumbing” webpage (i.e., personal directory page); (2) sign up for the referral network (which can be for free); (3) rate and/or review “Joe's Plumbing”; (4) to make “Joe's Plumbing” their personally preferred plumber; and/or (5) to list “Joe's Plumbing” in their personal directory. In one embodiment, the selection of “Joe's Plumbing” as a registered user's personally referred plumber will happen automatically if the registered user has signed up/registered as a participant of a service provided through system 100, through Joe's Plumbing's personal directory page. In another embodiment, the participant has the option to select whether “Joes Plumbing” will be its “Personally Referred” plumber or just be listed in the participant's directory page.

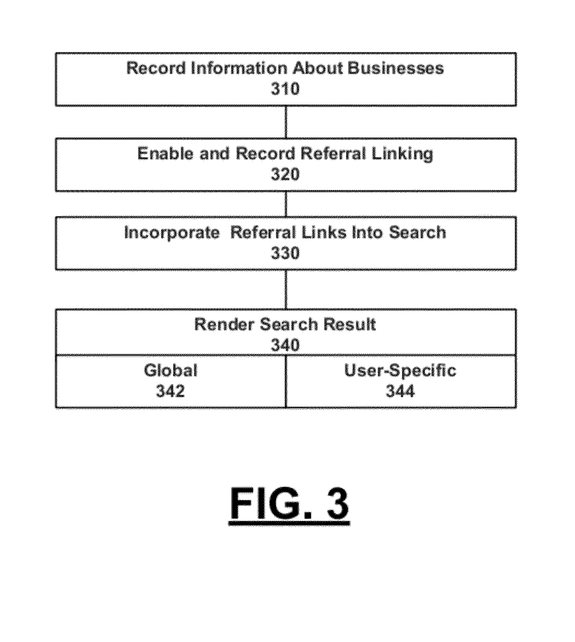

FIG. 3 illustrates a method for performing referral searching, according to an embodiment. A method such as described by FIG. 3 may be implemented using components such as described by an embodiment of FIG. 1. Accordingly, reference is made to elements of FIG. 1 for purpose of illustrating suitable elements or components for performing a step or sub-step being described.

The system 100 records information about businesses and organizations (310). In one embodiment, the system 100 may determine information about businesses/organizations from the businesses/organizations registering to become participants of system 100. During a registration process, a participant/business specifies information that includes the type(s) of products or service offered, the location(s) of the business, and other information that enables the participant's business to be classified. As an addition or variation, the system 100 uses third-party business directories and sources to gather and organize information about persons.

Subsequently, as described by an embodiment of FIG. 2 and elsewhere, referral links are enabled and recorded on system 100 (320). The database system 110 records data about referral links, so that the referral links made for each business are known and tabulated.

The referral links recorded in system 100 are then incorporated into search operations for businesses (330). In referral searching, a user enters some input that indicates their desire for locate a business of a particular type and/or classification. From this input, the search component 132 determines search criteria and parameters. For example, the user may wish to locate a local business, such as a plumber, or a non-local business, such as a mortgage broker. In order to find a plumber, the user may provide criteria or terms to classify the business (e.g. “plumber”) or the problem they are having (“clogged drain”). The person may specify their location, or alternatively, system 100 may infer the user's location based on information known about the user. In order to find the mortgage broker, the user may look to, for example, “refinance” or find an “equity loan”.

The search component 132 supplements the search criteria with parameters that utilize data determined from referral links. The data can be used to (i) filter our search results, by for example, eliminating or hiding search results that lack a threshold minimum of referral links; (ii) sorting or ranking search results based on businesses/organizations that have the most referral links.

In this way, search results that incorporate referral link data are generated (340). Data from referral links can be global (342) or user-specific (344). Global referral link data incorporates all referral links for businesses that otherwise match the search criteria. User-specific referral link data, on the other hand, is made specific to the user or the user's search or browsing experience. As examples, user-specific referral link data can affect a search result by ranking or otherwise identifying businesses that are (i) referral links of persons that are in the social network or community of the person performing the search; (ii) referral links from a particular participant, such as one that the searcher is relying on or trusts (e.g. searcher may know that a friend is undergoing a remodel, and may want to use the friend's referrals because the friend is deemed a good source); and (iii) referral links from a defined set of participants of system 100, such as from the user's specific social network (as known by, for example, the linked data set 116).

Search Results

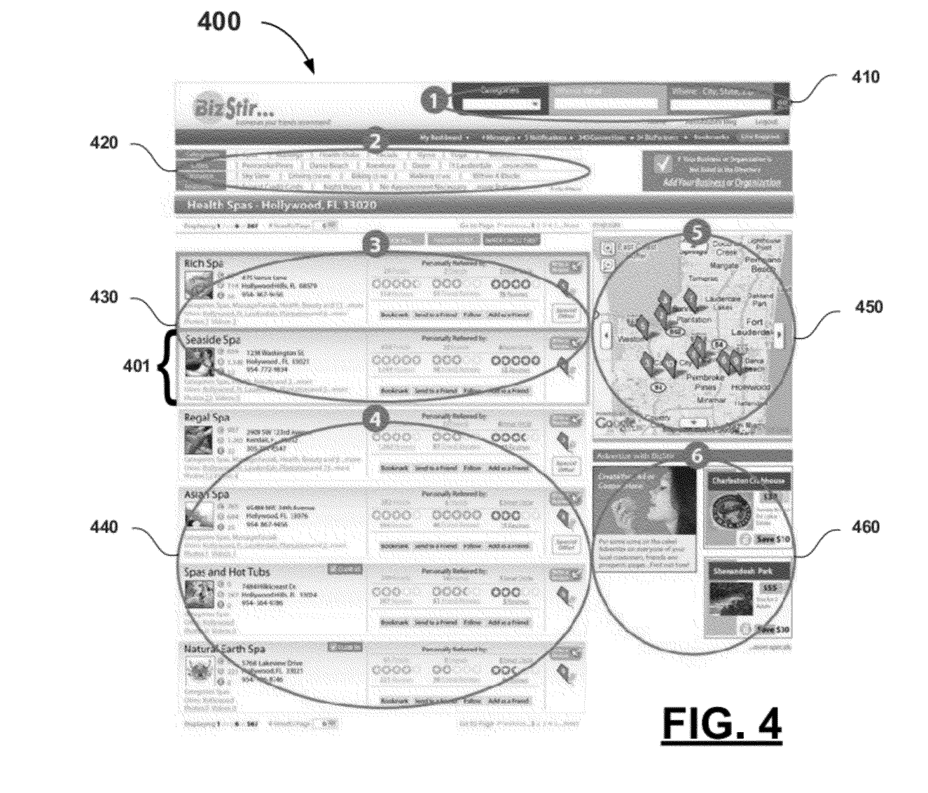

FIG. 4 illustrates a search result page that is generated for a user seeking to locate a business, in accordance with various embodiments described herein. More specifically, a search result page 400 can be generated using functionality such as described with an embodiment of FIG. 1, and further presented by other embodiments described above. With reference to FIG. 4, search result page 400 includes a search input feature 410 which allows the user to search for a business or organization by category, city, state, zip or combination of these attributes. It also allows the user to search by business name, organization name, or an individual's name (e.g., ‘friends’ of the user).

The ‘friends’ may correspond to, for example, one or more of the following: (i) participants that are directly linked socially or otherwise to the searcher through system 100, (ii) participants that are directly linked socially or otherwise to the searcher through another social networking environment, (iii) participants that are linked by more than 1° of freedom to the searcher (e.g. friend of social link), (iv) participants who share a common characteristic with the searcher, such as geography or membership to a particular organization or business, and/or (v) participants who were part of the same community, neighborhood, or deemed to have demographic similarity to the searcher. Accordingly, the term ‘friends’ is very example specific.

One or more business profile cards 401 may be presented in the search result sections 430 and 440. In an embodiment, the individual profile cards 401 each identify a business that is deemed to match search criteria input by the user (e.g. ‘Health Spas’ and ‘Hollywood, Fla.’). As such, the profile cards 401 include paragraph summaries or other descriptions of the represented businesses, as well as links to additional information about each of the businesses. Each of the profile cards 401 may also incorporate or integrate ratings. Ratings and other feedback about businesses may be recorded through use of feedback component 128. In addition to ratings, individual businesses may have reviews, which can also be recorded through use of feedback component 128.

Premium search results 430 are displayed prominently in the search result page 400 (e.g., at the top of the page). The premium search results 430 may include sponsored business profiles, and are thus highlighted by a different color background (e.g., blue) to indicate that they are paid advertisements. In some embodiments, businesses may pay to have their profile cards 401 placed in the premium search results 430 based on certain search criteria (e.g., category and/or zip code). The profile cards 401 may be presented in a hierarchical order based on a prioritization scheme. For example, a priority for each of the profile cards 401 displayed in the premium search results 430 may be assigned based on the number of business profiles that match a given search criteria and/or the amount of feedback that the business receives per day.

The search result page 400 further includes a listing of socially relevant search results 440, which are displayed less prominently than (e.g., below) the premium search results 430. These results may correspond to organic general search results based on the search criteria input by a user. According to an embodiment, the business profiles presented in the socially relevant search results 440 are non-paid advertisements. These search results may also be ranked according to a prioritization scheme. For example, a priority for each of the profile cards 401 displayed in the socially relevant search results 440 may be assigned based on the number of registered users that personally refer each corresponding business and/or the number of ratings the business receives.

A mapping feature 450 may be incorporated to display the geographical locations of the businesses shown in the premium search results 430 and/or the socially relevant search results 440. In some embodiments, the search result page 400 may also include a page filter feature 420 which allows a user to selectively filter the search results to be displayed in the premium search results 430 and/or the socially relevant search results 440.

Advertising space 460 is provided as additional real estate for paid advertisements. For example, this space may be used to place banner ads, coupons, and/or “pay-per-click” (PPC) ads. The PPC ads are paid for based on the number of times a member clicks on the advertisement. The advertisements presented in the advertising space 460 may not be relevant to the search criteria input by the user, however, these advertisements may be displayed based on a matching of a user's attributes (i.e., data about the user) to the business advertiser's targeting criteria.

Personal Directory Page

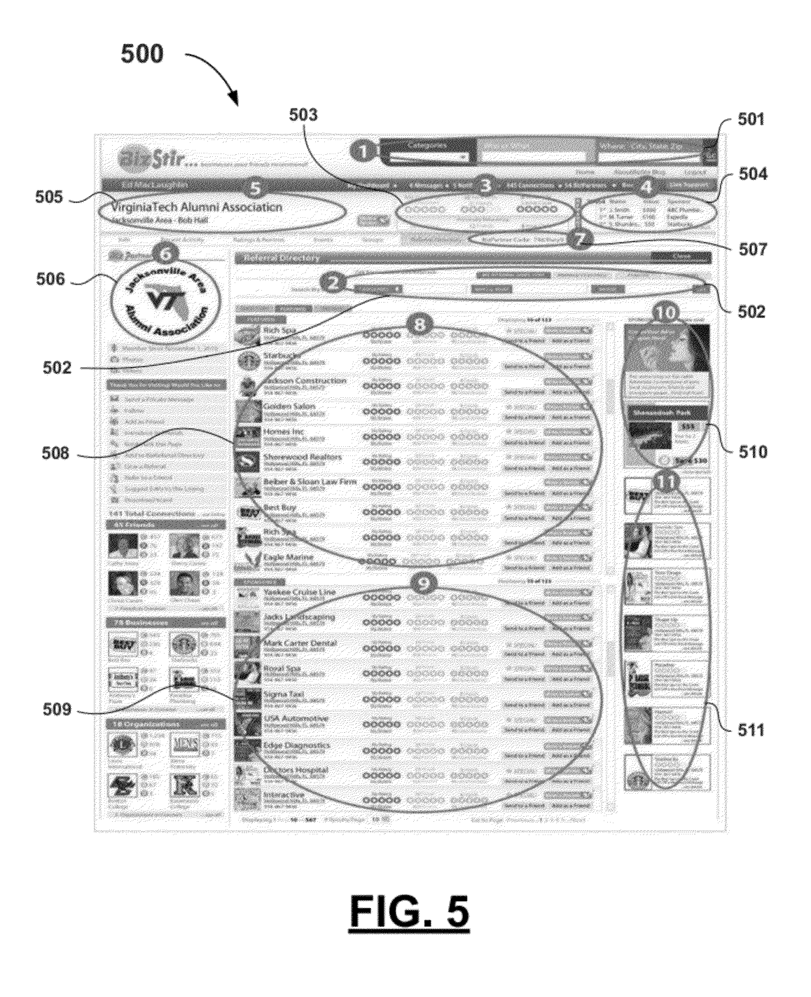

FIG. 5 illustrates a personal directory page 500, according to an embodiment. More specifically, a personal directory page 500 can be generated using functionality such as described with an embodiment of FIG. 1, and further presented by other embodiments described above.

As shown by FIG. 5, the personal directory page 500 can correspond to a webpage or online resource that is assigned and maintained for each participant of system 100. Thus, in one embodiment, when a user registers, the user is assigned a webpage (or functionally equivalent resource) that publishes information and other content specified by the user. The user can correspond to a person, whereas in the example shown, the participant corresponds to a business (e.g., “VirginaTech Alumni Association”). According to an embodiment, the personal directory page 500 is the page that is displayed to viewers other than the registered user associated with that directory.

The registered user's name and information is displayed in the profile section 505 of the personal directory page 500. A logo field 506 displays an image to be associated with the personal directory. The image allows a viewer of the personal directory page 500 to quickly associate the corresponding personal directory with a registered user. For example, businesses may choose to display their corporate logo in the logo field 506, while individuals may choose a portrait or photo. In some embodiments, the logo field can be modified at any time by the registered user.

The personal directory page includes both a general search feature 501 and a member directory search feature 502. The general search feature 501 allows a public user to search for a business or organization by category, city, state, zip or combination of these attributes. It also allows the user to search by business name, organization name, or an individual's name (e.g., ‘friends’ of the user). On the other hand, the member directory search feature 502 allows a public user to search the registered user's personal directory for a business or organization that the registered user would refer or recommend. This search may also be performed according to category, city, state, zip, or a combination of these attributes.

A leaderboard 504 displays the top “ClickPoint” earners. For example, ClickPoints may be earned by registered users based on their amount of interaction with the personal directory service (e.g., based on how many times they click on a business profile card and/or paid advertisements). According to an embodiment, the leaderboard 504 displays the top earners for a particular zip code (e.g., the zip code associated with the current personal directory). The leaderboard 504 encourages competition among registered user to participate and earn ClickPoints for recognition. In addition, the leaderboard 504 may display the top companies that have contributed awards for ClickPoints redemption for the current zip code. In this manner, the leaderboard 504 also facilitiates competition among local companies to provide better awards. The leaderboard 504 not only provides businesses an additional advertising opportunity, it also serves as a conversion tool by enabling them to incentivize consumers to try their products and services.

A partner code 507 is a unique code that may be used to track the relationships between registered users. For example, when an individual is invited to use the personal directory service by a registered user of the service, the invitee can enter the partner code 507 as part of the registration process in order to become part of the registered user's social group. Additionally, the partner code 507 may be used to track revenue sharing relationships.

The featured search results 508 display a list of preferred businesses or organizations for the registered user associated with the personal directory. A business or organization may purchase a profile card to appear on an opt-in list, from which a registered user can then choose one or more profile cards to appear on their personal directory.

The auto-populated search results 509 are then displayed below the featured search results 508. According to an embodiment, the auto-populated search results 509 includes business profiles that are presented in the registered user's directory automatically (i.e., not at the electon of the user). For example, a business or organization can purchase the right to have its profile appear on each registered user's personal directory for a given category and/or zip code. The profile descriptions may be formatted and retrieved from the business's profile data. In an embodiment, the profile cards appearing in the auto-populated search results 509 are prioritized according to their social relevancy.

Advertising space 510 is provided as additional real estate for paid advertisements. For example, this space may be used to place banner ads or business coupons. The advertisements presented in the advertising space 460 may not be relevant to the search criteria input by the user, however, these advertisements may be displayed based on a matching of a user's attributes (i.e., data about the user) to the business advertiser's targeting criteria.

In some embodiments, an additional PPC ad space 511 is provided for “pay-per-click” ads. The PPC ads are paid for based on the number of times a member clicks on the advertisement. PPC ads may have a more tightly defined target market than standard banner ads, and are customizable by the individual businesses or their advertising departments. For example, the business may define how much it wants to pay when a user clicks on a PPC ad and which registered users to target their PPC ads to. Whenever a user clicks on a PPC ad, that individual will be taken to the business's profile page, which may have information and/or other links to websites or online media to solicit their business.

A review-referral board 503 displays the ratings, reviews, and/or referrals of the registered user. The review-referral board 503 is herein in detail with reference to FIG. 6. Information presented in the review-referral board 600 is segmented into three groups: a general group 610 which includes ratings supplied by general users of the service; a friends group 620 which includes to ratings supplied by friends of the user viewing the page; and an associated group 630 which includes ratings supplied by a subset of the user's friends. For some embodiments, each group may be distinguished by a different color. In an example, orange represents the general group 610, green represents the friends group 620, and blue represents the associated group 630.

In an embodiment, the information displayed for each group may include: (i) the total number of members of that group who have reviewed the business and/or the total number of reviews they have completed (e.g., users may review a business more than once); (ii) the average rating the business received from the members of that group (e.g, as indicated by a number of stars); and (iii) the total number of members in the group that have personally referred the business in their own personal directory. In other words, users may review a business even if they don't personally refer them. The directory page 500 presents personal information about the participant, including the name of the participant and, in many cases contact information. For example, the case when the participant is a business, the contact information can list the address, fax number, e-mail, and various other information for enabling users of system 100 to contact and transact with the business.

In some embodiments, a user may create groups of friends based on business categories. For example, a user may have a total of forty friends who are also registered users of the personal directory service, but may only trust four of them to refer automotive repair shops. In this case, the user would create an “automotive repair shop” group, so that when the user selects that group, he or she will be presented with all of the businesses that are referred by that group.

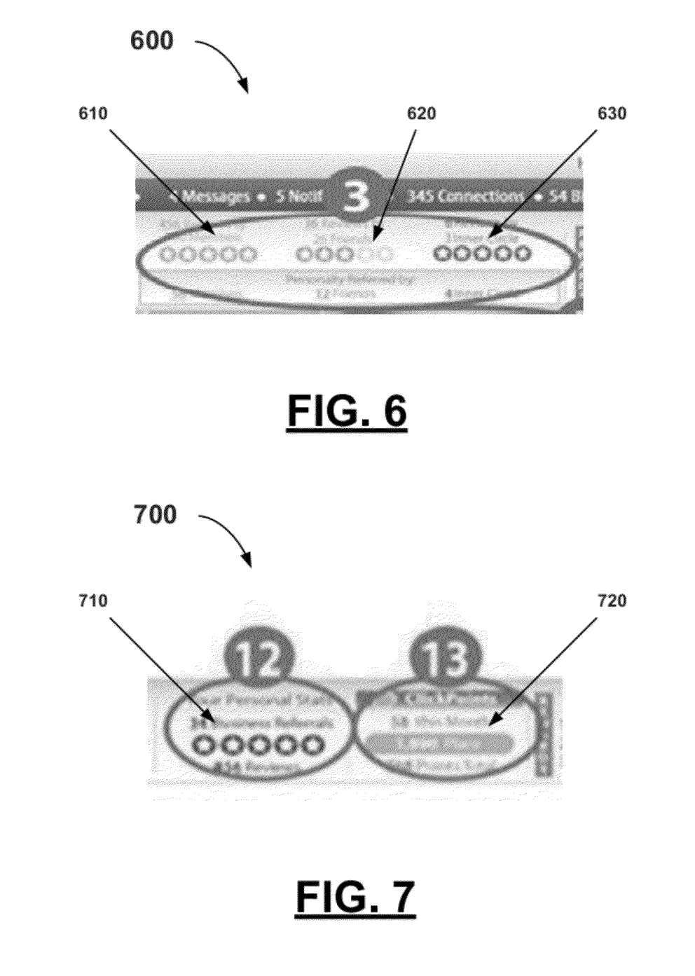

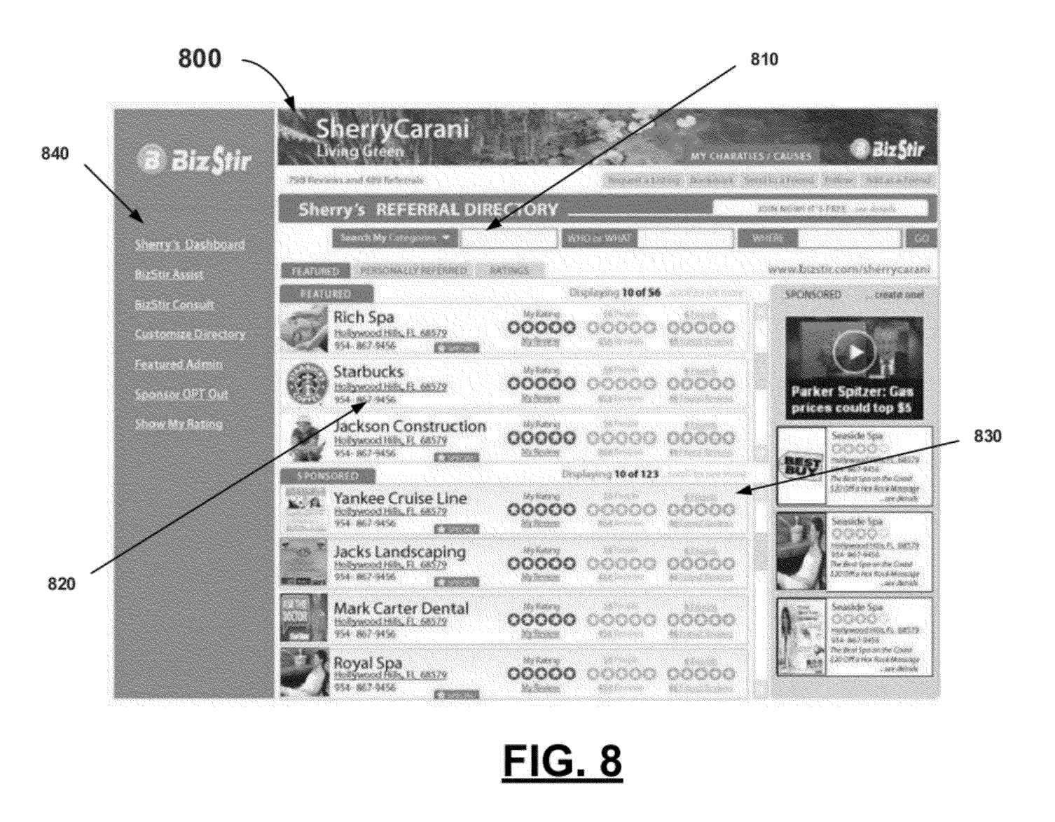

It should be noted that the review-referral board 600 is tailored for registered users that are businesses or organizations. If the registered user is an individual, he or she will be presented with a user dashboard 700, as shown in FIG. 7, in place of the review-referral board 600. The main difference between a business's review-referral board 600 and an individual's user dashboard 700 is the addition of a ClickPoints section 720, and the ratings section 710 relates the individual's activities rather than those of other users.

In an embodiment, the ratings section 710 displays the total number of business referrals, the average business rating, and total number of reviews the individual registered user has given to other businesses and organizations. The ClickPoints section 720 displays the number of ClickPoints the individual has accumulated over the month, the individual's rank for the month, and the total number of ClickPoints the individual has accumulated for the year.

FIG. 8 illustrates a personal directory page, according to another embodiment. The personal directory page 800 includes a search feature 810, featured search results 820, and sponsored search results 830, which may operate in a substantially similar manner as the member directory search feature 502, featured search results 508, and sponsored search results 509, respectively, described above in reference to FIG. 5.

The personal directory page 800 further includes a control panel 840 which presents a viewer with additional navigation options. For example, the control panel 840 may directly link the viewer to the registered user's profile page.

In some embodiments, the personal directory page 800 may be customizable and thus incorporated as part of a registered user's blog or personal website. For example, when incorporating the personal directory page 800 into a user's blog on “Living Green,” the control panel may be outfitted in a green color. Furthermore, the customized personal directory page 800 may be configured to only display environmental friendly businesses in the featured search results 820 and/or the sponsored search results 830. The search feature 810 may also offer more narrowly tailored categories and/or other search criteria.

In an alternative embodiment, the one or more components of the personal directory page 800 may be packaged and distributed as an application or “widget” which can then be integrated into a registered user's existing social media network (e.g., Facebook, Twitter, LinkedIn, MySpace, etc.). For example, the widget or application may be embedded into a third party website that is hosted outside of the network described in reference to FIG. 1. When a user of the third party website tries to perform a personal directory search, the application issues a request to a remote server, which may then retrieve the requested search parameters from the system 100. In some embodiments, applications may be designed for mobile operating systems (e.g., iOS, Android, WebOS, etc.). The application may have customizable parameters to suit a particular user and/or the context in which it is presented, however, the host of the third party website may be restricted from altering the application code or search parameters.

The application may thus be used as a tool for registered members to promote the business and organizations they refer. In addition, the application may be used to sign up new members for the personal directory service. For example, the application may restrict access to registered users only, or provide unregistered users with limited access to a user's personal directory. If an unregistered individual attempts to search a registered user's personal directory on his or her personal website or social media page, the application will require the individual to first log in or register a new account. When the individual registers, he or she will be “tracked” to the user associated with the personal directory under an affiliate tracking system.

Although illustrative embodiments have been described in detail herein with reference to the accompanying drawings, variations to specific embodiments and details are encompassed by this disclosure. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for promoting an organization on a social network environment, the method being implemented by one or more computers and comprising steps of:
associating a network resource to an organization, the network resource providing a medium on which the organization can provide information about itself and/or its products or services;
associating each participant in a population of participants of a social network with a corresponding network resource;
enabling the organization to request (i) individual participants in the population who have a relationship with the organization, and/or (ii) other organizations, to link their respective corresponding network resource with the network resource of the organization;
storing information that identifies (i) a plurality of organizations, (ii) individual participants in the population, and (iii) links between each of the plurality of organizations and individual users in the population and/or other organizations in the plurality of organizations, wherein the links between each of the plurality of organizations and the individual users include referral links; and
enabling access to each of the referral links from one or more network resources hosted outside of the social network.

2. The method of claim 1, wherein the one or more network resources hosted outside of the social network includes at least one of: (i) a web page, (ii) a blog, or (iii) a social media website.

3. The method of claim 1, further comprising presenting a list of businesses to a given user of the social networking, wherein the list incorporates data from referral links made to businesses in the list that are participants of the social network.

4. The method of claim 3, wherein presenting the list includes presenting a ranked listing of organizations, including identifying, from the plurality of organizations, a set of organizations that are of a particular category, wherein the ranked listing is based at least in part on a tally of individuals who have referral linked to each organization in the list.

5. The method of claim 3, wherein presenting the list includes determining information about a viewer of the list, and wherein presenting the list further comprises incorporating data about referral links that are made to businesses in the list and which from individuals who are pertinent to the viewer.

6. The method of claim 5, wherein determining information about a viewer includes determining one or more participants who are linked to the viewer, and wherein presenting the list further comprises incorporating data about referral links that are made to businesses in the list from the one or more participants who are linked to the viewer.

7. The method of claim 6, wherein determining information about a viewer includes determining one or more participants who have a common classification or geographic characteristic with the viewer, and wherein presenting the list further comprises incorporating data about referral links that are made to businesses in the list from the one or more participants who have the common classification or geographic characteristic with the viewer.

8. The method of claim 1, further comprising:
enabling referral searching by any user of the social network environment, including enabling a given user to specify, as search criteria, (i) information that identifies a type of organization, and (ii) a person or class of persons who have made a referral link to a business of the type.

9. The method of claim 8, further comprising using the search criteria to identify, from the stored information, one or more organizations that are of the type specified in the search criteria and which are linked to the referring user or organization.

10. The method of claim 9, further comprising presenting a ranked listing in response to receiving the search criteria, the ranked listing incorporating data from the referral link of the person or class of persons.

11. The method of claim 1, further comprising:
in response to a user action, presenting a list of business participants to a user, wherein individual business participant in the list are presented with data that is determined from referral links made to that business.

12. The method of claim 11, wherein presenting the list includes incorporating a tally of all referral links made for individual business participants in the list.

13. The method of claim 11, wherein presenting the list includes incorporating a tally of referral links made by either a particular participant, or class of participants, for individual business participants in the list.

14. The method of claim 11, wherein the user action includes a search operation initiated by the user.

15. The method of claim 11, wherein the user action includes a participant viewing another participant's directory page.

16. The method of claim 1, wherein the network resource assigned to each organization or each user is a web page.
